(19) United States
(12) Patent Application Publication
(10) Pub. No.: US 2026/0274750 A1
(43) Pub. Date: Sep. 17, 2026

(54) TWO-COMPONENT MORTAR COMPOSITION WITH TEMPERATURE-RESPONSIVE INHIBITOR

(71) Applicant: Hilti Aktiengesellschaft, Schaan (LI)

(72) Inventors: Armin Pfeil, Landsberg am Lech (DE); Florian Oesterlein, Jesenwang (DE)

(73) Assignee: Hilti Aktiengesellschaft, Schaan (LI)

(21) Appl. No.: 18/873,896

(22) PCT Filed: Jun. 21, 2023
(86) PCT No.: PCT/EP2023/066721

§ 371 Date: Dec. 11, 2024

(30) Foreign Application Priority Data
Jul. 6, 2022 (EP) 22183291.8

(51) Int. Cl. C04B 26/06; C04B 22/06; C04B 22/10; C04B 22/14; C04B 24/12; C04B 24/16; C04B 103/00; C04B 103/14; C04B 103/44

(52) U.S. Cl. CPC C04B 26/06; C04B 22/068; C04B 22/10; C04B 22/143; C04B 24/128; C04B 24/16; C04B 2103/0012; C04B 2103/0085; C04B 2103/14; C04B 2103/44

(57) ABSTRACT

A two-component mortar composition has a resin component (A) having at least one radically curable resin as a curable constituent, and a hardener component (B) having a curing agent for the radically curable resin of the resin component (A). The two-component mortar composition finds application in chemical fastening of fastening elements.

Two-component mortar composition comprising a resin component (A), which contains at least one radically curable resin as a curable constituent, and a hardener component (B), which contains a hardener for the radically curable resin of the resin component (A). The resin component (A) of the two-component mortar composition according to the invention further contains one or more conventional polymerization inhibitors selected from phenolic polymerization inhibitors, phenothiazine and/or derivatives thereof, stable organic radicals, oximes, and pyrimidinol or pyridinol compounds substituted in the para position to the hydroxyl group. The two-component mortar composition of the present invention is characterized in that the resin component (A) further contains an alkoxyamine compound as a temperature-responsive inhibitor. The invention also relates to the use of the mortar composition for chemically fastening elements, such as threaded anchor rods, reinforcing bars, threaded sleeves and screws, in boreholes made in a mineral substrate.

In order to securely fasten fastening elements, such as threaded anchor rods, reinforcing bars, threaded sleeves and screws in a mineral substrate, such as concrete, natural stone or plaster, the boreholes for receiving the fastening elements to be fastened are first drilled into the mineral substrate with the appropriate dimensions. The boreholes are then cleared of drilling dust and the two-component mortar composition is introduced into the borehole after mixing the resin component with the hardener component. The fastening element to be fastened is then inserted into the borehole filled with the mortar composition and adjusted. After the mortar composition has cured by reaction of the resin component with the hardener component, the fastening element is firmly held in the mineral substrate.

The load-bearing behavior of the fastening elements fastened in this way depends on several influencing variables, which are usually classified as internal and external variables. The internal influencing variables include the chemical composition of the mortar composition, the production process thereof and the packaging of the mortar composition, which typically comprises components present in two separate containers.

The external influencing variables include the type of borehole cleaning, the quality of the mineral substrate, for example the concrete, its humidity and temperature, and the type of borehole production.

Two-component mortar compositions based on urethane (meth)acrylate resins that cure by free-radical polymerization are known from EP 0 432 087 and EP 0 589 831.

The mortar compositions based on radically curing reactive resins known in the prior art and used as chemical bonded anchors usually contain polymerization inhibitors. Such conventional polymerization inhibitors are selected from phenolic polymerization inhibitors, phenothiazine and/or derivatives thereof, stable organic radicals, oximes, and pyrimidinol or pyridinol compounds substituted in the para position to the hydroxyl group. Polymerization inhibitors can be used, on the one hand, to ensure a certain storage stability of the mortar composition and, on the other hand, to set a desired working time. The working time is understood to be the time during which the mortar composition is still liquid so that a fastening element can be inserted. The working time must not be too short, so as to be able to insert the fastening element to be fastened into the borehole filled with the mortar composition and to align it appropriately. On the other hand, the working time must not be too long, otherwise the workflow on the construction site will be unnecessarily delayed.

The working time, however, is strongly temperature-dependent. The temperature found on a construction site is an external influencing variable that cannot be influenced or controlled. Due to the increased reactivity of the components in a mortar composition at elevated temperature, the working time decreases with increasing temperature. For mortar compositions that have a suitable working time at room temperature (about 20° C.), the working time obtained at, for example, 40° C. is too short. By increasing the amount of polymerization inhibitors, a suitable working time at 40° C. can be obtained. However, with such mortar compositions, provided with a higher amount of polymerization inhibitors, the working time at lower temperatures is then clearly too long.

Therefore, there is a need for chemical mortars that are stable under storage and have a working time suitable for practical use over a wider temperature range. That is to say, it is an objective of the present invention to provide chemical mortars that exhibit inhibition of the polymerization reaction at both low temperatures and elevated temperatures and that provide practically useful working times over a wide temperature range.

Surprisingly, it has been shown that the above-described problem is solved by a two-component mortar composition according to claim 1 or according to claim 3.

Preferred embodiments of the mortar composition according to the invention are provided in the dependent claims, which may optionally be combined with one another.

The invention also relates to the use of the mortar composition for chemically fastening fastening elements, such as threaded anchor rods, reinforcing bars, threaded sleeves and screws, in boreholes in a building material, such as wood or a mineral substrate, preferably concrete.

The present invention is based on the idea of additionally providing an otherwise conventional mortar composition with a temperature-responsive polymerization inhibitor. According to the invention, a “temperature-responsive polymerization inhibitor” is understood to be an inhibitor that shows no or hardly any inhibiting effect at low temperatures or room temperature, but makes a noticeable inhibiting contribution at higher temperatures. In interaction with conventional polymerization inhibitors, which are already established in mortar systems, such a temperature-responsive polymerization inhibitor could have the effect that a storage-stable mortar composition can be obtained, which has a working time suitable for practical use both at low temperatures and at elevated temperatures. Thus, a particular object of the present invention is to find compounds that are compatible with the particular chemistry in a complex mortar composition with typically many different constituents, and that exhibit no or hardly any inhibitory effect on the radical curing reaction at low temperature (such as room temperature), but exhibit a significant inhibitory effect at elevated temperature (such as 40° C. or more).

In a general embodiment, the invention comprises a two-component mortar composition comprising a resin component (A) containing at least one radically curable resin as a curable constituent, and a hardener component (B) containing a curing agent for the radically curable resin of the resin component (A), the resin component (A) containing one or more polymerization inhibitors selected from phenolic polymerization inhibitors, phenothiazine and/or derivatives thereof, stable organic radicals, oximes, and pyrimidinol or pyridinol compounds substituted in the para position to the hydroxyl group, characterized in that the resin component (A) further contains an alkoxyamine compound (1) having an activation energy Eₐ for homolysis of the R—O bond in the range of 100 to 120 kJ/mol.

Alkoxyamines are compounds containing the structural element R—O—N(R′R″), where R is an alkyl group and R′ or R″ is an organic group. The N—O—R group in an alkoxyamine is subject to homolysis of the R—O bond, i.e., a thermoreversible equilibrium is established between the alkoxyamine compound on the one hand and an alkyl radical R• and a nitroxyl radical •O—N(R′R″) on the other hand. For a given alkoxyamine compound, the homolysis has a certain activation energy Eₐ, which can be measured (or calculated). The determination of activation energies is generally well known to a person skilled in the art.

According to the invention, activation energies are determined by measuring the reaction rate constant k for the homolysis reaction using electron spin resonance (ESR: electron paramagnetic resonance, EPR) at a temperature of 50° C. The activation energy Eₐ is then calculated from the measured reaction rate constant k via the Arrhenius equation.

$$k = A \cdot {e}^{- \frac{Ea}{RT}}$$

The pre-exponential factor A here is A=2.4*10¹⁴s⁻¹. R is the general gas constant and T is the absolute temperature (in [K]). For the measurement, a solution of the alkoxyamine in tertbutyl benzene with a concentration of 10⁻⁴ mol l⁻¹ is used.

According to the invention, alkoxyamines having an activation energy Eₐ for homolysis of the R—O bond in the range of 100 to 120 kJ/mol are selected as the alkoxyamine compound (I). The inventors of the present invention have found that in a range of 100 to 120 kJ/mol of the activation energy Eₐ for homolysis of the R—O bond, there is hardly any homolysis at room temperature, so that there are also hardly any radicals for possible inhibition of the radical curing reaction of the radically curable resin of resin component (A) at room temperature. As a result, the radical curing reaction of the radically curable resin of resin component (A) at room temperature proceeds unaffected by the additional presence of alkoxyamine compound (I). However, at higher temperatures, such as at a temperature of 40° C. or higher, in the case of an activation energy Eₐ for homolysis of the R—O bond in the range of 100 to 120 kJ/mol, homolysis already takes place noticeably, so that sufficient radicals are present for additional inhibition of the radical curing reaction of the radically curable resin of resin component (A). Therefore, at higher temperatures, the additional presence of the alkoxyamine compound (I) has a significant inhibiting effect on the radical curing reaction of the radically curable resin of the resin component (A), i.e., there is a prolonged working time at higher temperature compared to the absence of the alkoxyamine compound (I). In this way, according to the invention, a mortar composition can be provided which exhibits a practical working time simultaneously at both low temperatures and elevated temperature.

In a preferred embodiment, the activation energy Eₐ for homolysis of the R—O bond in the alkoxyamine compound (I) is in the range of 100 to 110 kJ/mol. In a more preferred embodiment, the activation energy Eₐ for homolysis of the R—O bond in the alkoxyamine compound (I) is in the range of 100 to 108 kJ/mol.

In another general embodiment, the invention comprises a two-component mortar composition comprising a resin component (A) containing at least one radically curable resin as a curable constituent, and a hardener component (B) containing a curing agent for the radically curable resin of the resin component (A), the resin component (A) containing one or more polymerization inhibitors selected from phenolic polymerization inhibitors, phenothiazine and/or derivatives thereof, stable organic radicals, oximes, and pyrimidinol or pyridinol compounds substituted in the para position to the hydroxyl group, characterized in that the resin component (A) further contains an alkoxyamine compound of the following formula (II)

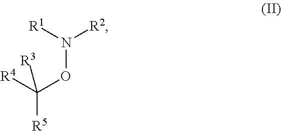

wherein
R¹ is a C₃₋₁₀ alkyl group;
R² is a C₂₋₁₀ alkyl group, wherein R¹ and R² together with the N atom to which they are bonded may form an optionally substituted, optionally unsaturated heteroalkyl ring,
R³ is H or a C₁₋₄ alkyl group,
R₄ is a C₁₋₄ alkyl group, and
R⁵ is an aryl or heteroaryl group.

The R³R⁴R⁵C—O bond in the alkoxyamine compound of formula (II) undergoes thermoreversible homolysis according to the reaction equation below:

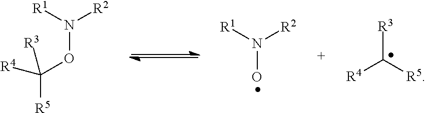

From the alkoxyamine compound of formula (II), a nitroxyl radical of formula •O—N(R¹R²) and an alkyl radical of formula (R³R⁴R⁵)C• are formed by homolysis of the R³R⁴R⁵C—O bond. According to the invention, at least one of the radicals formed in this process should be a good inhibitor for the radical polymerization of the radically curable resin of the resin component (A). Otherwise, the radicals formed should not interfere with the partly complex chemistry in the mortar system. According to the invention, this is achieved by suitable substitution in the alkoxyamine compound of formula (II).

Accordingly, R′ in the alkoxyamine compound of formula (II) represents a C₃₋₁₀ alkyl group. Preferably, R¹ is a C₄₋₈ alkyl group. R¹ may be linear or branched. Preferably, R¹ is branched at the α-position to the nitrogen atom to which it is bonded. In a preferred embodiment, R¹ represents a C₄₋₈ alkyl group branched at the α-position to the nitrogen atom. R¹ may further be substituted or unsubstituted.

R² in the alkoxyamine compound of formula (II) represents a C₂₋₁₀ alkyl group, for example a C₄₋₈ alkyl group. R² may be linear or branched. Preferably, R² is branched at the β-position to the nitrogen atom to which it is bonded. Additionally or alternatively. R² may optionally also be branched at the α-position to the nitrogen atom. Further, R² may be substituted or unsubstituted. For example, R² may be substituted at the α-position to the nitrogen atom.

Alternatively, R¹ and R² together with the N atom to which they are bonded may optionally form a heteroalkyl ring. This heteroalkyl ring may be unsubstituted or optionally substituted. Furthermore, the heteroalkyl ring may be saturated or optionally partially unsaturated.

R³ in the alkoxyamine compound of formula (II) represents H or a C₁₋₄ alkyl group. R³ may be substituted or unsubstituted. Furthermore, R³ may be linear or branched. In one embodiment, R³ is a hydrogen atom.

R⁴ in the alkoxyamine compound of formula (II) is a C₁₋₄ alkyl group. This means that the unpaired electron in the alkyl radical of the formula (R³R⁴R⁵)C• is located at an (at least) secondary or a tertiary C atom. R⁴ may be substituted or unsubstituted. Furthermore, R⁴ may be linear or branched. In one embodiment, R⁴ is a methyl group.

R⁵ in the alkoxyamine compound of formula (II) is an aryl or heteroaryl group, for example a C₆₋₂₀ aryl group, such as phenyl, naphthyl, anthracenyl or pyrenyl. That is to say, the unpaired electron in the alkyl radical of formula (R³R⁴R⁵)C• is in the α-position to a conjugated Tr-system. R⁵ may be substituted or unsubstituted. In one embodiment, R⁵ is naphthyl or pyrenyl, preferably pyrenyl.

Optional substituents in the optionally substituted groups R¹, R², R³, R⁴ or R⁵ are not particularly limited and may be selected, for example, from alkyl substituents (such as C₁₋₄ alkyl) or halogen atoms, etc. In one embodiment, R¹, R², R³, R⁴ or R⁵ optionally further contains a protonatable, a deprotonatable or a hydrolyzable group. Examples of protonatable optional substituents in R¹, R², R³, R⁴ or R⁵ include, but are not limited to, amine groups, such as dialkylamine (e.g., di-C₁₋₄ alkylamine). Examples of deprotonatable optional substituents in R¹, R², R³, R⁴ or R⁵ include, but are not limited to, carboxylic acid groups, sulfonic acid groups, sulfinic acid groups or phosphonic acid groups. Examples of hydrolyzable optional substituents in R¹, R², R³, R⁴ or R⁵ include, but are not limited to, alkyl esters (e.g., C₁₋₄ alkyl esters) of carboxylic acids, sulfonic acids, sulfinic acids, or phosphonic acids. In one embodiment, R² is substituted at the α-position to the nitrogen atom, wherein the substituent is preferably selected from a carboxylic acid alkyl ester group, sulfinate group, sulfonate group, and phosphonate group.

In one embodiment, the activation energy Eₐ for homolysis of the R³R⁴R⁵C—O bond in the alkoxyamine compound of formula (II) is in the range of 100 to 120 kJ/mol. In a preferred embodiment, the activation energy Eₐ for homolysis of the R³R⁴R⁵C—O bond in the alkoxyamine compound of formula (II) is in the range of 100 to 110 kJ/mol. In a more preferred embodiment, the activation energy Eₐ for homolysis of the R³R⁴R⁵C—O bond in the alkoxyamine compound of formula (II) is in the range of 100 to 108 kJ/mol.

As stated above, the two-component mortar composition of the present invention contains one or more conventional polymerization inhibitors in the resin component (A). According to the invention, the (conventional) polymerization inhibitors are selected from phenolic polymerization inhibitors, phenothiazine and/or derivatives thereof, stable organic radicals, oximes, and pyrimidinol or pyridinol compounds substituted in the para position to the hydroxyl group. Such polymerization inhibitors are usually present in amounts of 0.1 to 1.0 wt. %, in relation to the amount of radically curable resin of the resin component (A).

Examples of such polymerization inhibitors are, in particular, hydroquinone, substituted hydroquinones, e.g. 4-methoxyphenol, phenothiazine, benzoquinone or tert-butylpyrocatechol, as described for example in EP 1935860 A1 or EP 0965619 A1, nitroxyl compounds, in particular stable nitroxyl radicals, also called N-oxyl radicals, such as piperidinyl-N-oxyl or tetrahydropyrrole-N-oxyl, as described in DE 19531649 A1. Particularly preferably, 4-hydroxy-2,2,6,6-tetramethylpiperidine-N-oxyl (hereinafter referred to as tempol) is used for stabilization.

The polymerization inhibitors are preferably selected from phenolic compounds and non-phenolic compounds, such as stable radicals and/or phenothiazines.

Phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-8-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, pyrocatechol and butylpyrocatechols, such as 4-tert-butylpyrocatechol, 4,6-di-tert-butylpyrocatechol, hydroquinones, such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof, are possible as phenolic polymerization inhibitors, which are often a constituent of commercial radically curing reactive resins.

Phenothiazines, such as phenothiazine and/or derivatives or combinations thereof, or stable organic radicals, such as galvinoxyl radicals and N-oxyl radicals, are preferably taken into consideration as non-phenolic polymerization inhibitors.

Suitable stable N-oxyl radicals (nitroxyl radicals) can be selected from 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxy-piperidine (also known as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine and diethylhydroxylamine, as are described in DE 199 56 509. Further suitable N-oxyl compounds are oximes, such as acetaldoxime, acetone oxime, methyl ethyl ketoxime, salicyloxime, benzoxime, glyoximes, dimethylglyoxime, acetone-O-(benzyloxycarbonyl)oxime and the like. Furthermore, pyrimidinol or pyridinol compounds substituted in para-position to the hydroxyl group can be used as polymerization inhibitors, as described in DE 10 2011 077 248 B1.

The polymerization inhibitors can be used either alone or as a combination of two or more thereof, depending on the desired properties and the use of the resin mixture. The combination of the phenolic and the non-phenolic polymerization inhibitors enables a synergistic effect, as is also shown by the setting of a substantially drift-free setting of the gel time of the reactive resin composition.

In one embodiment, the mortar composition contains the alkoxyamine compound (I) or the alkoxyamine compound of formula (II) in an amount of 0.5 to 100 equivalents, in relation to one equivalent of the above-described (conventional) polymerization inhibitors, preferably 1 to 10 equivalents of alkoxyamine compound (I) or alkoxyamine compound of formula (II) per one equivalent of the conventional polymerization inhibitors.

The fastening of fastening elements using the two-component mortar composition according to the invention results in practical working times at both low and elevated temperatures. According to the invention, this is achieved by including, in addition to conventional polymerization initiators, a temperature-responsive photoinitiator, i.e. an alkoxyamine compound (I) or an alkoxyamine compound of formula (II), in the resin component (A) of the mortar compositions.

Further advantages of the invention can be found in the following description of preferred embodiments.

For the purposes of the invention, a “two-component mortar composition” is understood to mean a mortar composition consisting of a curable resin component and a hardener component for the resin component, the resin component and the hardener component being stored separately from one another so that no reaction of the hardener component with the resin component takes place during storage. Mixing the hardener component with the reactive resin immediately before application of the mortar composition starts the curing of the reactive resin.

The mortar composition according to the present invention may further contain at least one inorganic additive as a further constituent in the resin component (A) and/or the hardener component (B). The term “inorganic additive” refers to all inorganic constituents of the mortar composition. The use of inorganic additives in mortar compositions is known in the prior art. In this context, the mortar composition according to the invention may contain high amounts of inorganic additives. For example, the amount of inorganic additive lies in a range of 40 to 75 wt. %, in relation to the total weight of the mortar composition. In one embodiment, the amount of inorganic additive is in a range of 15 to 65 wt. %, such as 30 to 60 wt. %, in relation to the total weight of the mortar composition.

The inorganic additives can be selected, for example, from inorganic fillers, hydraulically setting or polycondensable inorganic compounds, modifiers and mixtures thereof.

Preferably, the inorganic additive comprises a filler which may be contained in the resin component (A) and/or in the hardener component (B). Examples of suitable fillers are BaSO₄, quartz, glass, corundum, porcelain, stoneware, barite, light spar, gypsum, talc, fly ash and/or chalk, as well as mixtures thereof, for example in the form of sands, flours or moldings, preferably in the form of fibers or spheres.

According to one embodiment of the invention, the inorganic additive further comprises a hydraulically setting or polycondensable inorganic compound, such as cement and/or gypsum, preferably cement that is free from iron oxide or contains only little iron oxide, such as aluminate cement. The hydraulically setting or polycondensable inorganic compound is preferably contained in the hardener component (A). In this case, the hardener component (B) comprises, in addition to the curing agent and the water optionally contained for phlegmatizing the curing agent, additional water for curing the hydraulically setting or polycondensable inorganic compound.

Lastly, the inorganic additive in the resin component (A) and/or in the hardener component (B) may contain other inorganic modifiers, such as thickeners and thixotropic agents, for example precipitated or fumed silica, bentonites and/or kaolin.

A two-component mortar composition of the present invention further comprises, in the resin component (A), at least one radically curable resin as a curable constituent. Radically curable resins for use in mortar compositions are known in the prior art. Radically curable compounds suitable according to the invention comprise, for example, ethylenically unsaturated compounds, compounds having carbon-carbon triple bonds, and thiol-yne/ene resins, as are known to a person skilled in the art.

Of these compounds, the group of ethylenically unsaturated compounds is preferred, which group comprises styrene and derivatives thereof, (meth)acrylates, vinyl esters, unsaturated polyesters, vinyl ethers, allyl ethers, itaconates, dicyclopentadiene compounds and unsaturated fats, of which unsaturated polyester resins and vinyl ester resins are particularly suitable and are described, for example, in the applications EP 1 935 860 A1, DE 195 31 649 A1 and WO 10/108939 A1. Vinyl ester resins are in this case most preferred due to the hydrolytic resistance and excellent mechanical properties thereof.

Examples of suitable unsaturated polyesters that can be used in the two-component mortar composition according to the invention are classified as follows:
(1) ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A;
(2) iso-resins: these are prepared from isophthalic acid, maleic anhydride or fumaric acid and glycols. These resins can contain higher proportions of reactive diluents than the ortho resins;
(3) bisphenol A fumarates: these are based on ethoxylated bisphenol A and fumaric acid;
(4) HET acid resins (hexachloroendomethylene tetrahydrophthalic acid resins): these are resins obtained from chlorine/bromine-containing anhydrides or phenols during the preparation of unsaturated polyester resins.

In addition to these resin classes, what are referred to as dicyclopentadiene resins (DCPD resins) can also be distinguished as unsaturated polyester resins. The class of DCPD resins is either obtained by modifying one of the above-mentioned resin types by means of a Diels-Alder reaction with cyclopentadiene, or said resins are alternatively obtained by means of a first reaction of a diacid, for example maleic acid, with dicyclopentadiene and then by means of a second reaction of the usual preparation of an unsaturated polyester resin, the latter being referred to as a DCPD maleate resin.

The unsaturated polyester resin preferably has a molecular weight Mₙ in the range of 500 to 10,000 daltons, more preferably in the range of 500 to 5,000 and even more preferably in the range of 750 to 4,000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as the unsaturated polyester resin, the acid value is preferably 0 to 50 mg KOH/g resin.

Within the meaning of the invention, vinyl ester resins are oligomers or polymers having at least one (meth)acrylate end group, what are referred to as (meth)acrylate-functionalized resins, which also include urethane (meth)acrylate resins and epoxy (meth)acrylates.

Vinyl ester resins, which have unsaturated groups only in the end position, are obtained, for example, by reacting epoxy oligomers or polymers (for example bisphenol A digylcidyl ether, phenol novolac-type epoxies or epoxy oligomers based on tetrabromobisphenol A) with (meth)acrylic acid or (meth)acrylamide, for example. Preferred vinyl ester resins are (meth)acrylate-functionalized resins and resins which are obtained by reacting epoxy oligomers or epoxy polymers with methacrylic acid or methacrylamide, preferably with methacrylic acid. Examples of compounds of this kind are known from the applications U.S. Pat. Nos. 3,297,745 A, 3,772,404 A, 4,618,658 A, GB 2217722 A1, DE 3744390 A1 and DE 4131457 A1. In this context, reference is made to the application US 2011/071234.

The vinyl ester resin preferably has a molecular weight Mₙ in the range of 500 to 3,000 daltons, more preferably 500 to 1,500 daltons (according to ISO 13885-1). The vinyl ester resin has an acid value in the range of 0 to 50 mg KOH/g resin, preferably in the range of 0 to 30 mg KOH/g resin (according to ISO 2114-2000).

Ethoxylated bisphenol A di(meth)acrylate having a degree of ethoxylation of 2 to 10, preferably of 2 to 4, difunctional, trifunctional or higher functional urethane (meth)acrylate oligomers, or mixtures of these curable constituents are particularly suitable as the vinyl ester resin.

Examples of epoxy(meth)acrylates of this kind are those of formula (A)

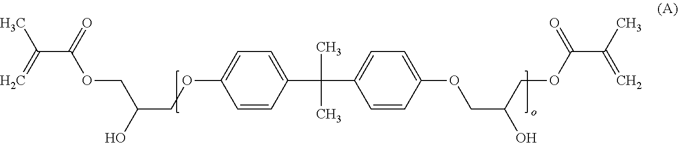

wherein n represents a number greater than or equal to 1 (if mixtures of different molecules are present with different n values and are represented by formula (A), non-integers are also possible as an average).

Further examples of the propoxylated or in particular ethoxylated aromatic diol, such as bisphenol A, bisphenol F or novolac (in particular di-)(meth)acrylates, are those of formula (B)

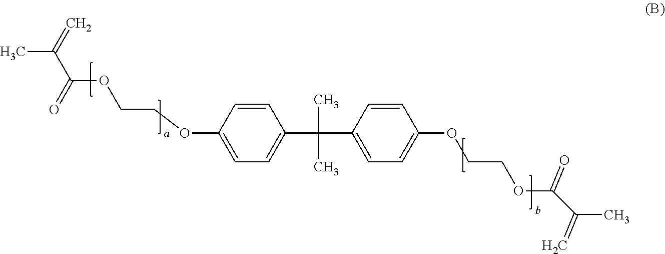

wherein a and b each independently represent a number greater than or equal to 0 with the proviso that preferably at least one of the values is greater than 0, preferably both 1 or greater (if mixtures of different molecules having different (a and b) values are present and are represented by the formula (B), non-integer numbers are also possible as the average value).

The known reaction products of di- or polyisocyanates and hydroxyalkylmethylacrylates, as described, for example, in DE 2 312 559 A1, adducts of (di)isocyanates and 2,2-propane bis[3-(4-phenoxy)-1,2-hydroxypropane-1-methacrylate]according to U.S. Pat. No. 3,629,187, and the adducts of isocyanates and methacryloyl alkyl ethers, alkoxybenzenes or alkoxycycloalkanes, as described in EP 44352 A1, are very particularly suitable. In this context, reference is made to DE 2312559 A1, DE 19902685 A1, EP 0684906 A1, DE 4111828 A1 and DE 19961342 A1.

Of course, mixtures of suitable monomers can also be used.

All of these resins that can be used according to the invention can be modified according to methods known to a person skilled in the art, for example to achieve lower acid numbers, hydroxide numbers or anhydride numbers, or can be made more flexible by introducing flexible units into the backbone, and the like.

In addition, the resin may contain other reactive groups that can be polymerized with a radical initiator, such as peroxides, for example reactive groups derived from itaconic acid, citraconic acid and allylic groups and the like, as described, for example, in WO 2010/108939 (itaconic acid ester).

The percentual proportion (in wt. % of the reactive resin) of radically curable resin in the resin component (A) is advantageously greater than approximately 5%, preferably greater than approximately 15%, and particularly preferably greater than approximately 20%. The percentual proportion (in wt. % of the resin component) of radically curable resin in the resin component is advantageously approximately 10% to approximately 90%, preferably approximately 15% to approximately 80%, more preferably approximately 20% to approximately 60%, more preferably approximately 25% to approximately 55%, even more preferably approximately 30% to approximately 55%, particularly preferably approximately 30% to approximately 50%, and very particularly preferably approximately 32% to approximately 45%.

The radically curable resin in component (A) of the mortar composition according to the invention preferably comprises a urethane (meth)acrylate resin and/or a (meth)acrylate-modified epoxy resin. In a preferred embodiment, the radically curable resin is a urethane (meth)acrylate resin.

To prepare a suitable urethane (meth)acrylate resin, an at least difunctional isocyanate can be reacted with one or more hydroxy-functional ethylenically unsaturated compounds, in particular with hydroxy-functional (meth)acrylic compounds.

The at least difunctional isocyanate for preparing the urethane (meth)acrylate resin can be an aromatic isocyanate, an aliphatic isocyanate, in particular a cycloaliphatic isocyanate, and an isocyanate group-containing prepolymer, which can also be used in mixture with one another.

Examples of suitable aliphatic and aromatic isocyanates include m-phenylene diisocyanate, toluylene-2-4-diisocyanate, toluylene-2-6-diisocyanate, hexamethylene-1,6-diisocyanate, tetramethylene-1,4-diisocyanate, cyclohexane-1,4-diisocyanate, hexahydrotoluylene diisocyanate, naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4,4′-biphenyl diisocyanate, 3,3′-dimethyldiphenylmethane-4,4′-diisocyanate, 4,4′,4″-triphenylmethane triisocyanate, polymethylene polyphenylisocyanate (PMDI), toluylene-2,4,6-triisocyanate and 4,4′-dimethyldiphenylmethane-2,2′,5,5′-tetraisocyanate.

Diphenylmethane-4,4′-diisocyanate, diphenylmethane-2,4′-diisocyanate and mixtures thereof are collectively referred to as MDI, and all may be used. Toluylene-2,4-diisocyanate, toluylene-2,6-diisocyanate and mixtures thereof are commonly referred to as TDI, and all may also be used.

Preferably, the polyisocyanate is selected from the group consisting of diphenylmethane diisocyanate (MDI), polymeric diphenylmethane diisocyanate (PMDI), toluylene diisocyanate (TDI), hexane diisocyanate (HDI), isophorone diisocyanate (IPDI), and mixtures thereof.

Isocyanate prepolymers prepared by reacting a stoichiometric excess of any polyisocyanate with an isocyanate-reactive compound as a chain extender can also be used, optionally in mixture with the aromatic and aliphatic isocyanates mentioned above.

Examples of such chain extenders are divalent alcohols, such as ethanediol, diethylene glycol, triethylene glycol and polyethylene glycol, propanediol, dipropylene glycol, tripropylene glycol and polypropylene glycol, 1,4-butanediol, 1,6-hexanediol, neopentyl glycol and diethanolamine, further aromatic alcohols, such as bisphenol A and bisphenol F or the ethoxylation products, hydrogenation products and/or halogenation products thereof, higher alcohols, such as glycerol, trimethylolpropane, hexanetriol and pentaerythritol, hydroxyl-group-containing polyethers, for example oligomers of aliphatic or aromatic oxiranes and/or higher cyclic ethers, such as ethylene oxide, propylene oxide, styrene oxide and furan, polyethers which contain aromatic structural units in the main chain, such as the polyethers of bisphenol A and F, and hydroxyl-group-containing polyesters based on the above-mentioned alcohols and polyethers with dicarboxylic acids or the anhydrides thereof, such as adipic acid, phthalic acid, tetra- or hexahydrophthalic acid, heteric acid, maleic acid, fumaric acid, itaconic acid, sebacic acid.

Chain extenders with aromatic structural units serve to stiffen the chains of the resin. Hydroxyl compounds with unsaturated structural units, such as fumaric acid, can be used to increase the crosslink density during curing. Branched or star-shaped hydroxyl compounds as chain extenders, in particular trihydric and higher alcohols as well as polyethers and/or polyesters containing the structural units thereof, yield branched or star-shaped urethane (meth)acrylates that exhibit a lower viscosity of the resins and improved solubility in reactive diluents.

The hydroxy-functional (meth)acrylic compound for preparing the urethane (meth)acrylate resin of resin component (A) is preferably a (meth)acrylic acid hydroxyalkyl ester, such as hydroxyethyl (meth)acrylate, hydroxypropyl (meth)acrylate, polyoxyethylene (meth)acrylate, polyoxypropylene (meth)acrylate, or a hydroxyl group-containing (meth)acrylic acid ester of polyhydric alcohols, such as pentaerythritol tri(meth)acrylate, glycerol di(meth)acrylate, trimethylol propane di(meth)acrylate and neopentyl glycol mono(meth)acrylate.

The designation “(meth)acryl . . . ” or “ . . . (meth)acryl . . . ” used here and in the following means that this designation is intended to include both the acrylic group and the methacrylic group.

The reaction of the at least difunctional isocyanate with the hydroxy-functional, ethylenically unsaturated compound is carried out in such a way that the resulting free-radically curable resin of resin component (A) is substantially free of free isocyanate groups. Here, “substantially free” means that the resin has an NCO content of less than 2%, preferably less than 1%, and particularly preferably less than 0.3%. For this purpose, the hydroxy-functional ethylenically unsaturated compound is used in a stoichiometric excess over the isocyanate groups.

Other radically curable resins that can be used are, for example, vinyl esters, epoxy (meth)acrylates, unsaturated polyester resins and mixtures thereof, alone or also together with the (poly)urethane (meth)acrylate described above.

Unsaturated polyester resins are obtained by reacting unsaturated dicarboxylic acids, such as o- and/or iso-phthalic acid, maleic acid and fumaric acid with dialcohols.

Epoxy (meth)acrylates are usually condensates of (meth)acrylic acid with glycidyl ethers of bisphenol A, bisphenol F or novolacs.

The radically curable resin is present, for example, in a proportion of 10 to 40 percent by weight in the mortar composition.

According to a preferred embodiment of the invention, the resin component (A) in all embodiments described above contains, as a further constituent, at least one reactive diluent which has at least one ethylenically unsaturated group. Suitable reactive diluents are, in particular, (meth)acrylate compounds and allyl and vinyl compounds.

Suitable reactive diluents are described in EP 1 935 860 A1 and DE 195 31 649 A1. Preferably, the resin mixture contains, as the reactive diluent, a (meth)acrylic acid ester, particularly preferably aliphatic or aromatic C₅-C₁₅ (meth)acrylates being selected. Suitable examples include: hydroxypropyl(meth)acrylate, 1,2-ethanediol di(meth)acrylate, 1,3-propanedioldi(meth)acrylate, 1,2-butanediol di(meth)acrylate, 1,4-butanediol di(meth)acrylate (BBDMA), trimethylolpropane tri(meth)acrylate, phenethyl(meth)acrylate, tetrahydrofurfuryl (meth)acrylate, ethyltriglycol(meth)acrylate, N,N-dimethylaminoethyl (meth)acrylate, N,N-dimethylaminomethyl (meth)acrylate, acetoacetoxyethyl (meth)acrylate, isobornyl (meth)acrylate, 2-ethylhexyl (meth)acrylate, diethylene glycol di(meth)acrylate, methoxypolyethylene glycol mono(meth)acrylate, trimethylcyclohexyl (meth)acrylate, 2-hydroxyethyl (meth)acrylate, dicyclopentenyloxyethyl (meth)acrylate and/or tricyclopentadienyl di(meth)acrylate, bisphenol-A-(meth)acrylate, novolac epoxy di(meth)acrylate, di-[(meth)acryloyl-maleoyl]-tricyclo-5.2.1.0.2.6-decane, dicyclopentenyloxyethylcrotonat, 3-(meth)acryloyl-oxymethyl-tricylo-5.2.1.0.2.6-decane, 3-(meth)cyclopentadienyl (meth)acrylate, isobornyl (meth)acrylate and decalyl-2-(meth)acrylate; PEG-di(meth)acrylate, such as PEG200 di(meth)acrylate, tetraethylene glycol di(meth)acrylate, solketal (meth)acrylate, cyclohexyl (meth)acrylate, phenoxyethyl di(meth)acrylate, methoxyethyl (meth)acrylate, tetrahydrofurfuryl (meth)acrylate, tert-butyl (meth)acrylate and norbornyl (meth)acrylate.

In principle, other conventional radically curable compounds, alone or in a mixture with the (meth)acrylic acid esters, can also be used, e.g., styrene, α-methylstyrene, alkylated styrenes, such as tert-butylstyrene, divinylbenzene and allyl compounds, of which the representatives that are not subject to mandatory labeling are preferred.

Particularly preferred reactive diluents are hydroxypropyl (meth)acrylate, 1,4-butanediol di(meth)acrylate and butanediol-1,2-di(meth)acrylate.

The reaction diluent serves, on the one hand, as a solvent for the radically curable resin and, on the other hand, as a comonomer that participates in the radical polymerization of the resin component. The use of reaction diluents leads to a further improvement in the adhesion of the cured mortar composition to the surfaces of the mineral substrate and/or the fastening element to be fastened.

The reactive diluent is present in the mortar composition, for example, in a proportion of from 0 to 25 percent by weight, such as from 4 to 25 percent by weight, or from 8 to 15 percent by weight. All radically curable compounds are preferably present in the mortar composition in a proportion of up to at most 30 percent by weight.

According to a further preferred embodiment of the invention, the resin component (A) contains at least one accelerator for the curing agent. Suitable accelerators, which are usually added to the resin mixture, are known to a person skilled in the art. These are, for example, amines, preferably tertiary amines and/or metal salts.

Suitable amines are selected from the following compounds, which are described for example in application US 2011071234 A1: dimethylamine, trimethylamine, ethylamine, diethylamine, triethylamine, n-propylamine, di-n-propylamine, tri-n-propylamine, iso-propylamine, di-iso-propylamine, tri-iso-propylamine, n-butylamine, iso-butylamine, tert-butylamine, di-n-butylamine, di-iso-butylamine, tri-iso-butylamine, pentylamine, iso-pentylamine, di-iso-pentylamine, hexylamine, octylamine, dodecylamine, laurylamine, stearylamine, aminoethanol, diethanolamine, triethanolamine, aminohexanol, ethoxyaminoethane, dimethyl(2-chloroethyl)amine, 2-ethylhexylamine, bis(2-chloroethyl)amine, 2-ethylhexylamine, bis(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, di-propylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis(2-hydroxyethyl)oleylamine, tris[2(2-hydroxyethoxy)ethyl]amine, 3-amino-1-propanol, methyl(3-aminopropyl)ether, ethyl-(3-aminopropyl)ether, 1,4-butanediol-bis(3-aminopropyl ether), 3-dimethylamino-1-propanol, 1-amino-2-propanol, 1-diethylamino-2-propanol, di-iso-propanolamine, methyl-bis(2-hydroxypropyl)amine, tris(2-hydroxypropyl)amine, 4-amino-2-butanol, 2-amino-2-methylpropanol, 2-amino-2-methylpropanediol, 2-amino-2-hydroxymethylpropanediol, 5-diethylamino-2-pentanone, 3-methylaminopropionitrile, 6-aminohexanoic acid, 11-aminoundecanoic acid, 6-aminohexanoic acid ethyl ester, 11-aminohexanoate-isopropyl ester, cyclohexylamine. N-methylcyclohexylamine. N,N-dimethylcyclohexylamine, dicyclohexylamine, N-ethylcyclohexylamine, N-(2-hydroxyethyl)cyclohexylamine, N,N-bis(2-hydroxyethyl)cyclohexylamine, N-(3-aminopropyl)cyclohexylamine, aminomethylcyclohexane, hexahydrotoluidine, hexahydrobenzylamine, aniline, N-methylaniline, N,N-dimethylaniline, N,N-diethylaniline. N,N-di-propylaniline, iso-butylaniline, toluidine, diphenylamine, hydroxyethylaniline, bis(hydroxyethyl)aniline, chloroaniline, aminophenols, aminobenzoic acids and esters thereof, benzylamine, dibenzylamine, tribenzylamine, methyldibenzylamine, α-phenylethylamine, xylidine, di-iso-propylaniline, dodecylaniline, aminonaphthalene, N-methylaminonaphthalene, N,N-dimethylaminonaphthalene, N,N-dibenzylnaphthalene, diaminocyclohexane, 4,4′-diamino-dicyclohexylmethane, diamino-dimethyl-dicyclohexylmethane, phenylenediamine, xylylenediamine, diaminobiphenyl, naphthalenediamines, toluidines, benzidines, 2,2-bis(aminophenyl)propane, aminoanisoles, aminothiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpipeidine, pyrroles, pyridines, quinolines, indoles, indolenines, carbazoles, pyrazoles, imidazoles, thiazoles, pyrimidines, quinoxalines, aminomorpholine, dimorpholineethane, [2,2,2]-diazabicyclooctane and N,N-dimethyl-p-toluidine.

Preferred amines are aniline derivatives and N,N-bisalkylarylamines, such as N,N-dimethylaniline, N,N-diethylaniline, N,N-dimethyl-p-toluidine, N,N-bis(hydroxyalkyl)arylamines. N,N-bis(2-hydroxyethyl)aniline. N,N-bis(2-hydroxyethyl) toluidine, N,N-bis(2-hydroxypropyl)aniline, N,N-bis(2-hydroxypropyl)toluidine, N,N-bis(3-methacryloyl-2-hydroxypropyl)-p-toluidine, N,N-dibutoxyhydroxypropyl-p-toluidine and 4,4′-bis(dimethylamino)diphenylmethane.

Polymeric amines, such as those obtained by polycondensation of N,N-bis(hydroxyalkyl)aniline with dicarboxylic acids or by polyaddition of ethylene oxide and these amines, are also suitable as accelerators.

Suitable metal salts are, for example, cobalt octoate or cobalt naphthenoate as well as vanadium, potassium, calcium, copper, manganese or zirconium carboxylates.

The resin mixture may also contain a co-accelerator, particularly when a transition metal compound is used as the accelerator. Depending on the transition metal compound chosen, the person skilled in the art will be able to select a suitable co-accelerator to achieve the desired cure properties. When a cobalt compound is used as the accelerator, the co-accelerator is preferably an amine and/or a 1,3-dioxo compound. When a copper compound is used as an accelerator, the co-accelerator is preferably an amine, an acetoacetamide, a potassium salt, an imidazole and/or a gallate or mixtures thereof. When a manganese compound is used as the accelerator, the co-accelerator is preferably a 1,3-dioxo compound, a thiol and/or a potassium or lithium salt or mixtures thereof. When an iron compound is used as the accelerator, the co-accelerator is preferably a 1,3-dioxo compound and/or a thiol, preferably in combination with an alkali metal salt. Suitable 1,3-dioxo compounds are acetylacetone, acetoacetates and acetoacetamides.

For example, the accelerators and/or co-accelerators are present in the mortar composition in a proportion of 0 to 1 wt. %, such as 0.01-0.7 wt. %.

Lastly, the mortar composition may contain other organic additives, such as adhesion improvers based on silane compounds, as known to a person skilled in the art, for example, from EP 2 371 782 A2 and WO 2011/072789 A1.

The curing agent for the radically curable resin of the resin component (A) contained in the hardener component (B) of the two-component mortar composition according to the invention comprises, preferably, at least one organic peroxide, for example dibenzoyl peroxide, methyl ethyl ketone peroxide, tert-butyl perbenzoate, cyclohexanone peroxide, lauryl peroxide, cumene hydroperoxide and/or tert-butyl peroxy-2-ethylhexanoate.

The organic peroxides are preferably phlegmatized, in particular by adding water as phlegmatizing agent and/or solvent. Suitable hardener components are known to a person skilled in the art and are available on the market.

Alternatively, a hardener system which is peroxide-free can be used for the curing, which system contains the following constituents:
at least one manganese compound as an accelerator and
a 1,3-dioxo compound as an initiator.

For this purpose, reference is made to DE 10 2011 078 785 A1.

Likewise alternatively, a hardener system which comprises the following constituents can be used for the curing:
at least one metal salt as an accelerator and
at least one compound containing thiol and/or thiol ester groups as an initiator.

For this purpose, reference is made to DE 10 2013 114 061 A1.

As a result of the combination or the mixing of the two constituents, radicals can be formed which, instead of previously customary radical formers, can trigger polymerization of non-aromatic double bonds, for example olefinic double bonds, for example acrylates or methacrylates.

As a further alternative, a hardener system which includes the following constituents can be used for the curing:
at least one metal salt as an accelerator and
as an initiator, at least one CH-acidic compound of the formula

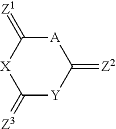

wherein
(i)
-A- represents —C(R¹) (R²)—,
—X— represents a bond, for —NR³— or —(CR⁴R⁵)ₚ—, or —O—,
Y represents NR⁶ or (CR⁷R⁸)_{q} or O,
where if X represents O, Y also represents O;
where preferably X represents (CR⁴R⁵)ₚ and Y represents CR⁷R⁸,
or X represents NR³ and Y represents NR⁶;
Z¹ represents O, S, S═O or S(═O)₂,
Z² represents O, S, S═O or S(═O)₂,
Z³ represents O, S, S═O or S(═O)₂ or R⁹ and R¹⁰,
p represents 1, 2 or 3, preferably 1 or 2
q represents 1, 2 or 3, preferably 1;
and the functional groups R¹, R², R³, R⁴, R⁵, R⁶, R⁷, R⁸, R⁹ and R¹⁰ each independently represent hydrogen, alkyl, aryl, aralkyl, cycloalkyl or cycloalkylalkyl and are each unsubstituted or substituted and/or heteroatoms (instead of C atoms;
preferably selected from O, N, such as NH or N-alkyl, and S, with the proviso that at least one of the functional groups Rand R² represents hydrogen,
or
(ii) open-chain compounds,
where the link forming the bridge —C(═Z³)— is missing,
-A- represents —C(R¹)(R²)—, X and Y each independently represent an in each case unbranched or branched, unsubstituted or substituted C₁-C₄ alkyl group or C₁-C₄ alkoxy group, which optionally has heteroatoms (instead of C atoms; in particular selected from O, N, such as NH or N-alkyl, and S) or preferably represent an in each case unsubstituted or substituted C₁-C₄ alkoxycarbonylmethyl group or a C₁-C₄ alkylcarbonylmethyl group, which optionally has heteroatoms (instead of C atoms; in particular selected from O, N, such as NH or N-alkyl, and S),
R¹ and R² are both hydrogen and
Z¹ and Z² have the above meanings;
or X represents an in each case unbranched or branched, unsubstituted or substituted C₁-C₄ alkyl group or C₁-C₄ alkoxy group or C₁-C₄ alkoxycarbonylmethyl group or C₁-C₄ alkylcarbonylmethyl group, which optionally has heteroatoms (instead of C atoms; in particular selected from O, N, such as NH or N-alkyl, and S),
Y and Z² together with the binding carbon atom are —CN,
Z¹ has the above meanings, and
R¹ and R² in each case as defined above with the proviso that at least one of the functional groups is hydrogen;
and/or salts thereof. For this purpose, reference is made to DE 10 2015 003 221 A1.

In both cases, the components used as accelerators in the form of a metal salt, also including metal complexes and metal oxides, are preferably one or more metal salts or in particular salts of organic and/or inorganic acids with metals, for example selected from cobalt, zirconium, zinc, cerium, tin, bismuth or preferably vanadium, manganese, copper or iron, or mixtures of two or more thereof, wherein the organic acids are preferably saturated, wherein vanadium and iron or in particular manganese and copper, optionally in the presence of one or two co-accelerators having metal content from the group of the abovementioned metals, are preferred, in particular in the form of salts or complexes having inorganic acids and/or carboxylate functional groups, such as carboxylates having CH₃, C₂-C₂₀ alkyl, a C₆-C₂₄ aryl functional group or C₇-C₃₀ aralkyl functional group, for example octanoate, e.g., 2-ethylhexanoate (isooctanoate), further neodecanoate, or acetylacetonate. Particularly preferred are manganese carbonate or carboxylates, such as Mn acetate or Mn octoate, copper carboxylates, such as copper octoate or copper naphthenate, copper quinolates, iron carboxylates, such as iron octoate and/or vanadium carboxylates and/or the group of metal salts having inorganic acids which, for example, comprise iron chloride, iron sulfate and copper chloride.

In a further alternative, a hardening system which comprises the following constituents can be used for the curing:
at least one metal salt as an accelerator and
at least one aldehyde and/or ketone and at least one primary amine as an initiator, and/or
b2) at least one imine which includes one or more imine structural increments of formula

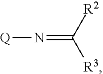

where, each independently:
Q represents the organic functional group of the amine used (in each case), or represents hydrogen; and
R² and R³ are each independently hydrogen and/or an unsubstituted or substituted, mono- or polybranched or straight-chain organic functional group which optionally has double bonds and/or heteroatoms and which includes at least one aliphatic, heteroaliphatic, alicyclic or heterocyclic molecular structure, or a combination of two or more of the aforementioned molecular structures;
and/or salts thereof,
For this purpose, reference is made to DE 10 2016 124 075 A1.

To set a suitable viscosity, the hardener component may contain a proportion of inorganic fillers and modifiers, such as thixotropic agents.

The two-component mortar composition according to the invention is preferably present in capsules, cartridges or film pouches which are characterized in that they comprise two or more separate chambers in which the resin component (A) and the hardener component (B) of the mortar composition are separately arranged so as to prevent a reaction.

For the use as intended, the resin component (A) and the hardener component (B) are discharged out of the separate chambers and mixed in a suitable device, for example a static mixer. The mixture of resin component (A) and hardener component (B) is then introduced into the previously cleaned borehole by means of a known injection device. The fastening element to be fastened is then inserted into the mortar composition and aligned. The curing agent of the hardener component (B) initiates the radical polymerization of the resin component (A), so that the mortar composition cures within a few hours under ambient conditions.

The invention therefore also relates to the use of the two-component mortar composition according to the invention for chemical fastening of fastening elements, in particular anchor threaded rods, reinforcing bars, threaded sleeves and screws, in boreholes in a building material, such as wood, or a mineral substrate, preferably concrete.

The invention is described below on the basis of a preferred exemplary embodiment, which, however, is not to be understood as limiting in any way.

### EXAMPLES

### Production of Components

The composition of the resin component used in Comparative Example V1 below and Application Example A1 is shown in Table 1 below.

TABLE 1

| | Resin component | | [wt. %] |
|---|---|---|---|
| Urethane methacrylate resin* | | | 50.2 |
| | Reactive diluent | BDDMA | 31.6 |
| | Reactive diluent | HPMA | 15.1 |
| | Accelerant | DiPpT | 1.7 |
| | Inhibitor | Tempol | 0.4 |

*Urethane methacrylate resin according to WO 2019/007667, Example C1

Table 2 below shows the composition of Comparative Example V1 and Application Example A1, in each case in parts by weight. In Application Example A1, the following compound (AV1) was used as the alkoxyamine compound of formula (I):

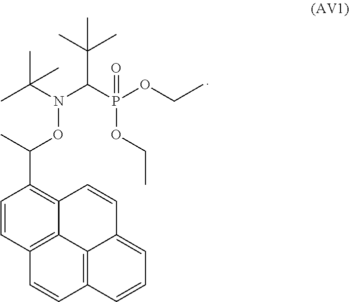 [SMILES: CCOP(=O)(OCC)C(N(OC(C)c1ccc2ccc3cccc4ccc1c2c34)C(C)(C)C)C(C)(C)C]

Alkoxyamine compound AV1 (diethyl (1-(tert-butyl(1-(pyren-1-yl)ethoxy)amino)-2,2-dimethylpropyl) phosphonate; MW: 523.6 g/mol) has an activation energy Eₐ for homolysis of the R—O bond of 105.32 kJ/mol. The amount of AV1 used in Application Example A1 corresponds to 4 equivalents, in relation to one equivalent of polymerization inhibitor (Tempol).

TABLE 2

| | | |
|---|---|---|
| Constituents | V1 | A1 |

A-component

| | | | |
|---|---|---|---|
| Resin component | | 20 | 20 |
| Silica | TS 720 | 0.6 | 0.6 |
| Alkoxyamine | AV1 | — | 2.2 |
| compound | | | |

B-component (Perkadox 20S)

| | | |
|---|---|---|
| Dibenzoyl peroxide | 20 | 20 |
| Calcium sulfate | 75 | 75 |
| Magnesium hydroxycarbonate | 5 | 5 |

Perkadox 20S, a mixture containing 20 wt. % dibenzoyl peroxide on calcium sulfate/magnesium hydroxycarbonate, available from Akzo Nobel, was used as the B-component in each case. 3 g of the respective A-component is tempered in a small speed mixer at 5° C. for at least 3 hours. Then, 900 mg of the B-component is mixed in the speed mixer (1500 rpm/60 s) and immediately a sample is weighed into a DSC crucible (aluminum 40 μL-D).

This is then followed by isothermal measurements of the curing curves at 20° C., 40° C. and 60° C. The crucible tempered at 5° C. is placed in the DSC cell tempered at the measuring temperature and the measurement is started. The gel time (time-to-peak) is measured from the time of mixing. The measurement (duration: 120 minutes) is carried out under N₂. The results obtained here (in [min]) are shown in Table 3.

TABLE 3

| Measurement temperature | V1 | A1 | Extension |
|---|---|---|---|
| 20° C. | 10 | 12.5 | 25% |
| 40° C. | 2.1 | 3 | 42% |
| 60° C. | 0.55 | 0.95 | 72% |

At room temperature, the addition of the alkoxyamine compound AV1 shows only a slight gel time extension of 25%. At 40° C., the gel time extension caused by the addition of the alkoxyamine compound AV1 is already noticeable at 42%. The gel time extension achieved by the addition of the alkoxyamine compound AV1 is particularly significant at 60° C. with 72%.

Components used:

| | |
|---|---|
| BDDMA | Evonik Performance Materials GmbH/DE |
| HPMA | Evonik Performance Materials GmbH/DE |
| DiPpT | Saltigo GMBH, Leverkusen/DE |
| Tempol | Evonik Performance Materials GmbH/DE |
| TS 720 | Cabot/Switzerland |
| Perkadox 20S | Akzo Nobel/USA |

1. A two-component mortar composition, comprising:
a resin component (A) containing at least one radically curable resin as a curable constituent, and
a hardener component (B) containing a curing agent for the radically curable resin of the resin component (A), the resin component (A) containing one or more polymerization inhibitors selected from the group consisting of phenolic polymerization inhibitors, phenothiazine and/or derivatives thereof, stable organic radicals, oximes, and pyrimidinol or pyridinol compounds substituted in the para position to the hydroxyl group,
wherein
the resin component (A) further contains an alkoxyamine compound (I) of the formula R—O—N(R′R″), where R is an alkyl group and R′ and R″ are each an organic group, and which has an activation energy Eₐ for homolysis of a R—O bond in a range of 100 to 120 kJ/mol.

2. The two-component mortar composition according to claim 1, wherein the alkoxyamine compound (I) has an activation energy Eₐ for homolysis of the R—O bond in a range of 100 to 110 kJ/mol.

3. A two-component mortar composition, comprising:
a resin component (A) containing at least one radically curable resin as a curable constituent, and
a hardener component (B) containing a curing agent for the radically curable resin of the resin component (A), the resin component (A) containing one or more polymerization inhibitors selected from the group consisting of phenolic polymerization inhibitors, phenothiazine and/or derivatives thereof, stable organic radicals, oximes, and pyrimidinol or pyridinol compounds substituted in the para position to the hydroxyl group,
wherein
the resin component (A) further contains an alkoxyamine compound of following formula (II) 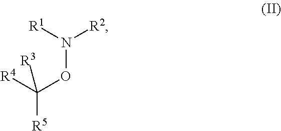
wherein
R¹ is a C₃₋₁₀ alkyl group;
R² is a C₂₋₁₀ alkyl group, wherein R¹ and R² together with a N atom to which they are bonded may form an optionally substituted, optionally unsaturated heteroalkyl ring,
R³ is H or a C₁₋₄ alkyl group,
R⁴ is a C₁₋₄ alkyl group, and
R⁵ is an aryl or heteroaryl group.

4. The two-component mortar composition according to claim 3, wherein in the alkoxyamine compound of formula (II)
R¹ is branched in α-position to the nitrogen atom,
R² is branched at β-position to the nitrogen atom, and optionally branched or substituted at α-position to the nitrogen atom,
R⁵ is an unsubstituted or substituted C₆₋₂₀ aryl group, and
wherein R¹, R², R³, R⁴ or R⁵ optionally further contains a protonatable, deprotonatable or hydrolyzable group.

5. The two-component mortar composition according to claim 3, wherein the alkoxyamine compound of formula (II) has an activation energy Eₐ for homolysis of the R³R⁴R⁵C—O bond in a range of 100 to 120 kJ/mol.

6. The two-component mortar composition according to claim 3, wherein the alkoxyamine compound (I) or the alkoxyamine compound of formula (II) is present in an amount of 0.5 to 100 equivalents, in relation to one equivalent of polymerization inhibitors.

7. The two-component mortar composition according to claim 1, wherein the resin component (A) and/or the hardener component (B) contains as a further constituent at least one inorganic additive selected from the group consisting of inorganic fillers, hydraulically setting or polycondensable inorganic compounds, modifiers and mixtures thereof.

8. The two-component mortar composition according to claim 7, wherein the at least one inorganic additive comprises a filler selected from the group consisting of BaSO₄, quartz, glass, corundum, porcelain, stoneware, barite, light spar, gypsum, talc, fly ash, chalk, and mixtures thereof.

9. The two-component mortar composition according to claim 7, wherein the at least one inorganic additive comprises a hydraulically setting or polycondensable inorganic compound selected from the group consisting of cement and gypsum and mixtures thereof.

10. The two-component mortar composition according to claim 7, wherein the at least one inorganic additive comprises a modifier selected from the group consisting of thickeners, plasticizers, thixotropic agents and mixtures thereof.

11. The two-component mortar composition according to claim 1, wherein the radically curable resin is selected from the group consisting of compounds based on urethane (meth)acrylate, compounds based on epoxy (meth)acrylate, methacrylates of alkoxylated bisphenols, and compounds based on further ethylenically unsaturated compounds.

12. The two-component mortar composition according to claim 1, wherein the resin component (A) contains at least one reactive diluent as a further constituent.

13. The two-component mortar composition according to claim 1, wherein the resin component (A) comprises at least one accelerator as a further constituent.

14. The two-component mortar composition according to claim 1, wherein the hardener component (B) contains at least one organic peroxide.

15. The two-component mortar composition according to claim 1, wherein the two-component mortar composition is in a capsule, a cartridge or a film pouch, the resin component (A) and the hardener component (B) being arranged in separate chambers.

16. A method, comprising:
chemically fastening of fastening elements with the two-component mortar composition according to claim 1.
